(19) United States
(12) Patent Application Publication
(10) Pub. No.: US 2019/0142222 A1
(43) Pub. Date: May 16, 2019

(54) Method for Operating a Food Processor

(71) Applicant: Vorwerk & Co. Interholding GmbH, Wuppertal (DE)

(72) Inventors: Maria Resende, Lisboa (PT); Wenjie Yan, Düsseldorf (DE)

(73) Assignee: Vorwerk & Co. Interholding GmbH, Wuppertal (DE)

(21) Appl. No.: 16/308,278

(22) PCT Filed: Jun. 8, 2017
(86) PCT No.: PCT/EP2017/064000

§ 371 Date: Dec. 7, 2018

(30) Foreign Application Priority Data
Jun. 10, 2016 (DE) 10 2016 110 715.8

(51) Int. Cl. A47J 43/07; A47J 27/00

(52) U.S. Cl. CPC A47J 43/0716; A47J 2043/0733; A47J 27/004

(57) ABSTRACT

The invention relates to a method (100) for operating a food processor (10), wherein in a preparation mode at least one processing device (50) of the food processor (10) is controlled to at least partially-automatically prepare at least one food.

The present invention relates to a method according to the type detailed herein. Furthermore, the invention relates to a food processor as well as to a computer program and a use of a food processor.

Food processors that can prepare food in an at least partially automatic manner are known from the prior art. A food processor of this kind is disclosed for example in document DE 10 2013 106 691 A1, the entire disclosure of which is incorporated in this application.

A food processor of this kind comprises one or more processing devices which comprise a mixer, for example. In this case, the processing device can be controlled such that an autonomous and/or an at least partially automatic preparation is possible. This also comprises in particular the execution of recipe steps by means of the food processor.

In this case, the at least partially automatic preparation takes place in particular in accordance with programming of the food processor. The programming comprises for example specifications, such as specific settings for control parameters, which are defined depending on recipe steps (preparation steps) and/or the user setting. It is furthermore conceivable for the specifications to be adjusted depending on the food that is to be prepared. For example, preparing rice requires a different mixer speed and a different temporal mixing duration than preparing cream. The type of food is specified for example by the recipe or by the user of the food processor and set accordingly on the food processor. Depending on the type of food, the preparation is then carried out in accordance with a specified mixing duration and/or mixer speed that is optimal for preparing the food in question.

Just as well, the specifications may include different preparation steps, which e.g. respectively comprise information about the type and/or amount and/or preparation of food. The performing of the preparation steps serves to prepare the food in a certain fashion, in particular by a certain setting of the control parameters, so that a predetermined preparation result is ensured, as far as possible.

However, it is often problematic in this case that the optimal preparation and therefore the optimal values for the control parameters, such as the mixer speed and/or the mixing duration, are dependent on and influenced by a very large number of factors. Factors of this kind are for example the food characteristics (amount, percentage fat, manufacturer and the like) and/or the environmental conditions (such as the room temperature). In order to determine the optimal values for the control parameters it is therefore often not sufficient to use pre-stored values for the control parameters that were set depending on the food type, i.e. in a food-dependent manner. In particular, it is then often not possible to achieve good and comparable preparation results in the case of different requirements and environmental conditions. In this case, it is often not sufficient to take into account merely isolated factors from a technical point of view.

Furthermore, there is a problem that the preparation by means of the food processor is adaptive and optimizable only to a limited extend, even if it is carried out partially-automatically. Influencing factors, such as properties of the food influencing on the preparation can often not sufficiently be taken into account.

An object of the present invention is therefore that of overcoming the above-described disadvantages at least in part. The object of the present invention is in particular that of allowing improved and/or simplified, at least partially automatic preparation of food. Furthermore, in particular a preparation by means of the food processor for a food intended for preparation, i.e. in particular identifying and/or defining the optimal control parameters for the food in question, with respect to the state and/or the type of the food shall be improved. In this case in particular the constructive complexity and/or the costs should be reduced and/or the adaptiveness and automatability of the food processor for various preparations should be increased.

The above object is achieved by a method, a food processor, and a computer program product as described herein and by a use as described herein. Further features and details of the invention can be found in the relevant dependent claims, the description and the drawings. In this case, features and details that are described in connection with the method according to the invention of course also apply in connection with the food processor according to the invention and the computer program product according to the invention and the use according to the invention, and vice versa in each case, and therefore, with regard to the disclosure, reciprocal reference is always/can always be made to the individual aspects of the invention.

The object is achieved in particular by a method for operating a food processor, wherein preferably in a preparation mode at least one processing device of the food processor is controlled, so as to least partially automatically prepare (i.e. in particular at least partially without manual control of the preparation, e.g. by automatic regulation and/or monitoring of a temperature of a heating element and/or by an automated recipe processing by the food processor) at least one food and/or different foods. The control is carried out for example by means of a control device and/or by means of a control signal which is emitted by the control device and/or by a processing device.

Furthermore, preferably the following steps are provided, which, in particular, are carried out successively, or in any order:
a) identifying at least one control value by a first acquisition of at least one control parameter during the preparation mode, wherein the control parameter is specific to the preparation,
b) identifying at least one result value by a second acquisition of at least one result parameter, wherein the result parameter is specific to the preparation and/or the result of the preparation,
c) recording the control value and the result value in a preparation record, so that this (the preparation record) is assigned to the preparation (as a recorded preparation), and/or to record the completed preparation as a recorded preparation. In particular, the completed preparation is a recorded preparation, in the case that an assigned preparation record exits for it. The recording according to step c) preferably occurs prior to and/or during and/or after a stop of the preparation. The preparation record preferably is stored digitally in a data storage unit, such as a flash memory.

This in particular provides the advantage that the further preparations can be performed and/or adapted by means of the preparation record and/or can be adapted to the recorded preparation. Thus, preferably, conditions of the surroundings can be taken into account e.g. to optimize the preparations, since the result parameter (by means of which e.g. the qualitative result of the preparation can be assessed) depends upon the conditions of the surroundings. Thus, e.g. in further preparations, the knowledge gained by the acquisition can be used by means of the preparation record in order to ensure an adaptive preparation and high quality. It can preferably be provided that in step a), the at least one control parameter corresponds to a first acquisition value, and/or in step b) the at least one result value corresponds to a second acquisition value.

In particular, according to step a), multiple control values are identified for different control parameters, e.g. for the rotary speed and/or the temperature and/or the rotary direction and/or combinations thereof. Furthermore, preferably, according to step b), multiple result values are identified for multiple different result parameters, e.g. by one or multiple sensors on the food processor or the like. In particular, the result values form a temporal course, respectively time curve, of the values identified by the sensor(s).

In this case, the control parameter is e.g. specific to the preparation in that the direct processing of the food is adapted and/or controlled (e.g. by the setting of the speed and/or temperature, which can respectively be control parameters). The result parameter is e.g. specific to the preparation result in that a (future estimated or actual) completion timepoint is determined and/or the preparation mode is ended (e.g. by a user input that deactivates the mixer) and/or the preparation quality and/or the food per se is assessed (e.g. by a temperature and/or visual acquisition on the food and/or by a user input, which in particular evaluates the result). In other words, the result parameter particularly serves to influence and/or evaluate the preparation result. Thus, the result parameter can also concern the (or a certain stop) control signal and/or the (or a certain evaluation) user input and/or the control parameter in as far as they determine and/or influence stop and/or the result of the preparation or of an individual preparation step. In particular, in this case, the result parameter is however configured differently from the control parameter.

Preferably, it can also be possible that an in particular automatic or partially-automatic adaption of the preparation occurs, so that the preparation is conducted dependent upon the preparation result. To that end, a desired/predetermined preparation result can be determined from the preparation record. For example, based upon the recorded result value, the preparation result can be determined, in particular a further completion timepoint or the like. Preferably, the determination of the preparation result occurs based upon an optimization specification, in particular based upon an optimization algorithm. It can likewise be possible that the preparation specification includes further information that serves to determine the preparation result. This further information is e.g. identified by means of sensor acquisitions of the food processor and/or recorded in step c) (e.g. camera data or the like). The preparation result is, for example, a certain consistency or a certain other property of the at least one prepared food. In particular, the control parameters can be adapted then in such a way that an actual result of the preparation comes as close as possible to the predetermined preparation result. Thus, in particular the preparation does not depend on the time (or at least not exclusively), but (also) on the preparation result. Just as well, the preparation steps and/or their order and/or duration do preferably not dependent (only) on the time, but (also) on the preparation result.

It can be possible that for the start of a further preparation, which is at least partially-automatically carried out by the food processor, a preparation record is also loaded. The further preparation is then effected in particular in such a way that the preparation steps are adapted by means of the preparation record in that the at least one recorded result value and/or the at least one recorded control value and/or the at least one preparation result are taken into account during the preparation for the evaluation. The evaluation is e.g. effected by a processing device of the food processor. The preparation is effected e.g. in that at least partially during the preparation, at least one identified actual value of the control parameters and/or at least one acquisition value is evaluated dependent on at least one acquired result value and/or the at least one recorded control value and/or the at least one preparation result and, based thereupon, a new target value is identified for the control parameters. On the basis of the determined target value, e.g. a control signal can be emitted, so that the preparation is adapted to the preparation record. The evaluation preferably occurs based upon an optimization specification (e.g. optimization algorithms), which is e.g. locally or remotely (i.e. on a remote computer) stored and/or retrieved.

In particular, the control signal influences the at least one control parameter of the preparation, such that the control parameters, for example the mixer speed and/or mixing duration, can preferably be determined and/or checked and/or controlled and/or adapted by the control device. It can be provided that first, for recording the preparation, a /first preparation mode and/or the record is active initiated by the user of the food processor, in order to thereupon at least partially and/or repeatedly and/or cyclically perform steps a) to c) of the method according to the invention. After the initiation, e.g. by the selection of a recipe and/or by the input of the user on the food processor, in particular subsequently the preparation can be recorded as a preparation to be recorded in that according to step a) and b) the control value and result value is determined, and is recorded (e.g. stored) according to step c). The stop of the recording and/or of the preparation to be recorded is predefined e.g. by the recipe and/or by the input of the user. This stop event, i.e. the stopping of the recording and/or of the preparation to be recorded, is e.g. a result parameter and/or can be identified by means of the result value. After the stop, e.g. a persistent storage of the preparation record and/or the storage of further information (e.g. about the recipe selection) occurs, whereby preferably the preparation record is assigned to the recorded preparation.

In particular, the control parameters include at least one of the following (processing parameters):
temperature (in particular for the regulated control of a heating power of a heating element of the food processor),
mixer speed,
mixing duration
an electric variable on the food processor, in particular a motor current of the food processor,
mixing direction (left/right)
activation of a user prompt, e.g. a certain display on the display,
an acquirable/measurable variable, which can be acquired by at least one sensor of the food processor,
preparation duration, e.g. also the total preparation duration or the preparation duration of individual preparation steps,
at least one acquisition variable and/or at least one preparation parameter.

In particular, the result parameter includes at least one of the following parameters:
a user input (user input) for the manual stop of a preparation step and/or preparation mode,
a user input for evaluating the result, in particular a quality of the preparation and/or of the food,
a physical and/or measurable variable on the food processor, which provides conclusions in the quality of the preparation and/or the temperature (on or in the food processor) and/or the rotary speed (of a mixer) and/or the properties of the food and/or further properties of a processing device of the food processor,
an event, in particular a stop event, and/or an information from a recipe information, which leads to the automatic stop of the preparation step and/or preparation mode,
at least one acquisition variable and/or at least one preparation parameter.

In this case, the preparation can include one or multiple preparation steps (each with one or multiple foods), wherein in particular the time duration of the individual preparation steps is referred to a preparation duration and the time duration of the entire preparation is referred to as the total preparation duration.

Optionally, it can be provided that at least one of the following steps is carried out after step c):
d) evaluating the preparation record when a further preparation mode for a further preparation is initiated, preferably by a user input, in particular by a recipe selection, and/or after and/or during the performing of the further preparation,
e) emitting at least one control signal to influence the further preparation mode which, in particular, was initiated before, depending on the preparation record and/or the evaluation (according to step d), so that in particular the further preparation occurs in a manner adapted to the preparation record in this further preparation mode.

Preferably, steps d) and e) serve for the reproduction of the record according to step c) and/or a recorded course of the control and(or result values and/or of the result of the recorded preparation. For example, the result of the recorded preparation can be a (user-specific) state of the food, such as consistency (e.g. of cream, sauces or the like), a grinding level (e.g. of granules or the like), or a frying level (e.g. of onions or the like), which is in particular reproduced by the further preparation. To that end, it is conceivable that the preparation steps for achieving the result in the further preparation are different from the preparation steps of the recorded preparation, so that in particular (merely) the result is reproduced. Alternatively or additionally, the preparation record can also serve for the reproduction of the individual preparation steps, in particular also of the recorded course, and thus of the entire recipe. In this way, existing recipes can be modified for example, and/or new recipes can be recorded in a simple and reliable manner.

It can preferably be provided that the evaluation is effected to compare a result of a further preparation with the recorded result value. In particular, an at least partially-automatic adaption of the preparation steps can be effected, in order to e.g. reproduce the result of the recorded preparation by the further preparation. The adaption occurs in particular automatically, i.e. no active user input and/or manual control (for adaption) being required. In particular, the adaption can occur in such a way that not the preparation steps are identically reproduced, but the preparation steps (possibly deviating from the record) are adapted in such a way that the result of the recorded preparation is achieved or reproduced. To that end, a repeated monitoring and/or an anew acquisition of the result parameter is effected in the further preparation in order to be able to make a comparison with the desired result, and/or perform a regulated preparation.

For example, beforehand according to step b), in the second acquisition, the result value can be identified as such a result value which indicates the stopping of a preparation step. Preferably, based upon the second acquisition and/or based upon the result value, a preparation duration for this preparation step can be determined and/or recorded according to step c). It is also conceivable that a recipe information includes data about multiple preparation steps, so that e.g. according to step c), a first preparation duration for a first preparation step and/or a second preparation duration for a second preparation step can be recorded. In particular, in the initiation and/or performing of a further preparation, the respective preparation step of this further preparation can be adapted to the previously recorded preparation duration. For example, when starting a first preparation step of the further preparation, a timer is started, and after reaching the first preparation duration, which had previously be recorded, the control signal is emitted. The control signal serves e.g. to stop the first preparation step, and/or to initiate a second preparation step. This process can occur in particular similarly for the second preparation duration and the second preparation step. This provides the advantage that a continuous preparation quality can be ensured.

According to another advantage, it can be provided that the recorded control value and/or the recorded result value is assigned to at least one preparation step in the preparation mode (or a preparation step of the preparation), wherein an at least partially automatic adaption of the assigned preparation step, in particular a preparation duration of the preparation step, preferably mixing duration, and/or of the or a further control parameter is effected in a further preparation mode based upon the preparation record. Preferably, for a certain preparation, which is e.g. predetermined by a recipe information, multiple preparation steps are provided. Preferably, each of these preparation steps can be assigned, based upon the preparation record, an individual preparation duration, which in particular corresponds to the preparation duration that the respective preparation step had in the record and/or identification (according to steps a), b) and/or c)). This provides the advantage that by means of only one record, the results of the preparation can be reproduced even for future preparations.

Furthermore, it can be provided in the scope of the invention that for the initiation of the in particular at least one further preparation mode a recipe selection (in particular by a user input) is carried out, and an adaption of the preparation mode, in particular by means of the preparation record, is effected only in the event that a recipe selection defined by the preparation record corresponds to the performed recipe selection for the recorded preparation (i.e. which was used in the recorded preparation). In this way, it is ensured that the preparation record is assigned to a certain recipe and/or is reproduced only for this specific recipe selection. To that end, e.g. the predetermined recipe selection in step c) is also stored in the preparation record. The comparison with the (current or performed) recipe selection of the further processing with the predetermined recipe selection is effected e.g. by a processing unit of the food processor. Thus, it is also conceivable that multiple preparation records are recorded for different recipes or recipe information, and/or simultaneously stored. To that end, a particularly flexible use of the method is possible for different recipes.

Furthermore, it is conceivable that during at least one further preparation mode, in particular in a corresponding recipe selection, a monitoring of the result parameters and/or control parameters for the identification of the monitoring values is effected, wherein in particular the monitoring values are compared with the values of the, preferably corresponding, preparation record, and preferably a further preparation is adapted in the further preparation mode by means of the comparison, so that in particular the further preparation is adapted to the recorded preparation. Alternatively or additionally, it can likewise be provided that the preparation record is adapted by means of the identified monitoring values, e.g. in the case that a monitoring value (which was determined e.g. by a monitoring of the result parameter) is more optimal than a recorded result value, and/or in particular only in the event that a quality parameter of the result of the further preparation exceeds a recorded quality parameter of the result of the recorded preparation. The quality parameter can e.g. be a consistency of the food, which is predetermined (by user input). Thus, in particular based upon the further preparation, the preparation record can be improved, when e.g. the further preparation is more relevant, i.e. leads to a more optimal result and/or a result otherwise more relevant to the user.

It can also be possible that in step a) and/or b), all parameters are acquired as control parameters and/or result parameters, which influence the preparation and the result in the preparation and/or are acquired by sensors on the food processor. To that end, an as complete as possible recording of the preparation is carried out.

Furthermore, it is conceivable that by a recipe selection, at least one recipe information is selected, which includes at least one or all and/or the individual preparation steps for the preparation in the preparation mode, wherein preferably the recipe selection is effected outside the preparation mode, e.g. by a user input. In particular, it can possible that the recipe information includes multiple data about the type and/or amount and/or quality of the at least one prepared food. It is for example conceivable that this data is at least partially displayed on a display of the food processor for a user. Furthermore, it can also be provided that this recipe information and/or the data is adapted based upon this preparation record, in order to optimize the preparation result.

Preferably, it can be provided in that scope of the invention that by an evaluation of the preparation record, a deviation from a recipe information is determined, wherein in particular the at least one control signal is emitted in such a way that the deviation is taken into account in a further preparation mode. For example, prior to the initiation of the further preparation mode, the deviation can be evaluated e.g. by a processing unit of the food processor, and/or the preparation can be controlled after the subsequent initiation of the preparation mode in such a way that the deviation is taken into account. This ensures that the further preparation deviates from the recipe information in such a way that the preparation is optimized based upon the preparation record.

According to another advantage, it can be provided that the preparation record is supplemented with information about at least one preparation step and/or about the at least one food used in the recorded preparation, so that in particular a new recipe information is created, wherein the new recipe information is selected by a recipe selection, in particular by a user input, in order to perform a further preparation mode dependent upon the preparation record. In this way, it can be possible e.g. that a user records a completely new recipe and can subsequently perform the preparation according to the record by the selection of the new recipe information again. To that end, it can be provided, for example, that by a user input, both the individual preparation steps and the food used and/or prepared by it are configured and/or input e.g. also based upon the type and/or amount. As a result, a very versatile use of the food processor is made possible.

It can be particularly advantageous if, according to step a) a temporal first course of the control parameter is acquired, and/or recorded according to step c), and/or according to step a) a temporal second course of the result parameter is acquired and/or recorded according to step c). In particular, it can be possible that the record of the first course and/or of the second course is effected by the recording of the identified control values and/or result values. Correspondingly, it is conceivable that the preparation record includes the first course and/or the second course. Thus, in a further preparation, the first and/or second course can e.g. be evaluated by means of the preparation record in order to e.g. carry out an (in particular time-dependent) adaption of the further preparation by means of at least one of the said courses or curves. This allows a particularly exact reproduction of the recorded preparation.

Furthermore, it can be possible that the control parameters include at least one of the following parameters:
a temperature on the food processor, preferably on a heating element /heating) and/or the like, and/or further temperatures on the food processor, and/or a temperature of the surroundings of the food processor,
a speed on the food processor, preferably of a mixed of the food processor,
a preparation duration of an individual preparation step of the preparation in the preparation mode, and/or further preparation durations of further preparation steps,
an overall preparation duration,
at least one amount and/or quality of the prepared food,
at least one rotary speed on the food processor, preferably of a mixer,
at least one acquisition variable,
at least one preparation parameter.

In this case, it is conceivable that according to step a) at least one or multiple of these acquisition parameters are acquired, and/or at/or at least one or multiple control values are correspondingly identified and/or evaluated and/or recorded. Thus, the result of the preparation record can be further optimized.

Further advantageously, according to step b), at least two result values can be identified by the second acquisition of respectively different result parameters, preferably a first result parameter by a first sensor, and/or a second result parameter by a second sensor, wherein the sensors preferably are arranged on the food processor and/or on the surroundings of the food processor. In particular, it is possible that a first result parameter is a first preparation parameter, preferably a temperature on the food processor, preferably on the prepared food, and/or a second result parameter is a second preparation parameter, preferably a motor current, wherein preferably the first preparation parameter is different from the second preparation parameter. This also makes a further optimization of the preparation record possible, in order to e.g. be able to carry out a very precise reproduction of the recorded preparation. In particular, combinations of different control parameters can likewise be acquired and/or the corresponding control values can be recorded (e.g. the combination of speed and/or rotary direction and/or the temperature of the heating element and/or the preparation duration).

It can further be of advantage if the selection of the result parameter and/or control parameter to be acquired is stored in a parameter default, wherein in particular the first and/or second acquisition is/are performed dependent on the parameter default, wherein particularly preferably the parameter default is read-out preferably in a manner independently from the recipe. In particular, an operator can perform a user input in order to select the recipe (the recipe information) and/or thereby determine the parameter default. This ensures e.g. that the preparation record can reliably be assigned to a certain recipe and/or prepared food.

In particular, it is conceivable that an adaption is effected based upon the preparation record, in order to take into account, in particular, user preferences that can preferably be acquired by the record. Thus, e.g. in the identification and recording (e.g. in particular in accordance with steps a) to c), the result value can be used to determine, when the preparation step ends, whereby a user information is determined. In this case, the user information does not or nor only provide information about the preparation duration. Preferably, the user information and/or the result value also provide information on how the preparation result was or should be in the record. In this way, it is possible that the result of the preparation is recorded, e.g. independently of the specific preparation and/or preparation duration, in particular in step c) of the method according to the invention. A further preparation can then be effected based upon the preparation record in such a way that the preparation steps are adapted in such a way that the recorded result is reached. The further preparation can, as the case may be, also be conducted in a manner different from the preparation in the record, since the specific preparation steps are also dependent upon the used food or conditions of the surroundings, which can be different from the ones of the time when the record was taken. In this case, (e.g. dependent on the used food or conditions of the surroundings, or further preparation variables), a preparation can be conducted which leads to the (desired) recorded result. To that end, e.g. an evaluation of the preparation record and/or of the acquired food parameter and/or preparation parameter and/or conditions of the surroundings and/or acquisition variables can be effected by an (e.g. electronic) processing unit of the food processor.

Preferably, a monitoring device is provided, which performs an identification of at least one acquisition value by an acquisition of at least one acquisition variable specific to a preparation state on the food processor. Preferably, the food processor comprises the monitoring device, which in particular performs the identification of the acquisition values, at least during the preparation mode, as respectively temporally successive acquisition values (by the acquisition). Particularly preferably, the acquisition value is, or the acquisition values are specific to at least one preparation parameter of the food processor and/or a preparation state of the food and/or for the control parameter. A first acquisition value corresponds to e.g. the control value here, and/or a second acquisition value corresponds to the result value. In particular, it is conceivable that a first acquisition variable corresponds to the control parameter and/or depends therein. Just as well, it can also be possible that a second acquisition variable corresponds to the result parameter and/or depends thereon.

In particular, at least one of the acquisition variables specific to the preparation state includes at least the one control parameter. In this way, e.g. the temperature on the food processor, the mixing direction or the like can be evaluated based upon the acquisition value. Thus, preferably the at least one acquisition value depends on the control parameter.

Alternatively or additionally, the at least one acquisition variable specific to the preparation state also includes (besides or in place of the at least one of the control parameters) at least one physical variable (i.e. in particular the result parameter) acquired on the food by at least one sensor, in particular a measuring variable. The acquisition value depends e.g. on the temperature on the food or the like. In particular, the acquisition value includes a visual information about the food. In this way, it is possible to also evaluate further information, in particular about a result of the preparation, based upon the at least one acquisition value.

In this case it is preferably also possible for more than one acquisition variable, e.g. at least 2 or at least 3 or at least 4 or at least 5 or at least 6 or at least 10 or at least 20 different acquisition variables, in particular also respectively different, to be identified, in particular during one preparation mode. Preferably, (all) the acquired acquisition variables, such as the first and second acquisition variable, differ from one another with respect to their type, such that for example a first acquisition variable is in the form of a motor signal (i.e. for example intensity such as intensity of current of the motor signal) or the like and a second acquisition variable is in the form of a temperature or the like. Furthermore, it can also be provided that the first acquisition variable is a variable (directly) on the food and/or is directly influenced by the food (such as the motor current), and in particular the second acquisition variable is a variable of the surroundings of the food processor and/or the food and/or is a variable influenced by the said surroundings. It may also be possible for the number and/or type of the acquired acquisition variables to be defined on the basis of the (set) food to be prepared, e.g. by means of a processing device of the food processor, and/or on the basis of user input and/or a recipe selection and/or an acquisition variable selection. The preparation can thus be significantly improved. The control parameters and/or the result parameters include at least one acquisition variable.

For example, a control parameter such as the temporal mixing duration and/or the mixer speed is influenced and/or defined by the emission of the control signal. It is thus possible to determine the optimal control parameters and/or to influence the preparation accordingly on the basis of the food (to be prepared) that is provided for the preparation. The control signal is emitted for example by a processing device and/or by the monitoring device and/or by a control device and/or by an electronics of the food processor.

Within the context of the invention, the term “acquisition value” preferably refers to a value and/or measurement value of the acquisition variable that can be acquired (for example by means of a sensor), i.e. in particular a physical variable or measurement variable which is acquired in particular at the food processor, wherein the preparation parameter preferably is or influences the acquisition variable. The identification of the acquisition values in particular comprises measuring (acquiring) the acquisition variable, wherein it is possible, in this context, for “measuring” to be understood both as a quantitative and as a qualitative acquisition and therefore not necessarily needing to comprise defining a unit and/or quantitative statement regarding the acquisition variable. The acquisition value may for example merely be a voltage value and/or a current value, for example a curve being analyzed by means of the time-dependent analysis and/or consulted for the analysis information, without specific comparison with a unit. In this case, the acquisition value is e.g. proportional to and/or can be clearly associated with the actual value of the acquisition variable. Preferably, the control value and/or the result value corresponds to the acquisition value or similarly has the properties described in this context.

Within the context of the invention, the acquisition variable, in particular the control parameter and/or the result parameter (and/or the preparation parameter) preferably denotes an acquirable (measurable) physical variable (such as e.g. the speed of the mixer) and/or a control variable (such as the motor signal) and/or influencing variable (such as the temperature) at the food processor, the acquisition variable and/or the preparation parameter preferably being (exclusively) indirectly influenced by the preparation state, such as the motor current of an electrical motor for driving the mixer. For example, a change in the consistency of the food brings about a changed (mixing) resistance on the mixer and thus indirectly influences the motor current. The time curve of the measurement values or acquisition values is thus preferably dependent on a curve of the mixing resistance of the mixer.

Furthermore, it can be provided in the context of the invention that the first and/or the second acquisition variable respectively comprise variables measurable physically on the food processor, which influence a property of the food that can be changed by the preparation respectively in a different manner, and/or are influenced by this property, so that they are in particular specific to a preparation state, wherein preferably the first acquisition variable and/or the second acquisition variable and/or each (all) acquisition variables influence this changeable property of the food respectively in a different manner, or are influenced by the property in a different manner. Preferably, the first acquisition variable is a signal, e.g. a motor current of a motor of a drive for the processing device, and/or the second acquisition variable is a temperature of the prepared food. For example, some or all of the acquisition variables can directly or indirectly depend on a mixing resistance of the mixer of the food processor. Furthermore, it can be possible that at least one of the acquired acquisition variables depends directly or indirectly on a state of the prepared food, in particular during the preparation mode. In this way, conclusions can be made to the state of the food by based upon for example, the acquisition values.

Furthermore, it can provided in the context of the invention that the acquisition variables and/or the control parameter and/or the result parameter each comprise at least one of the following variables, in particular preparation parameters, and/or each are at least one of the following variables and/or are influenced thereby.
a rotary speed of the processing device, preferably of a mixer of the food processor,
a parameter of a drive, preferably of a motor of the drive, e.g. a torque,
a motor signal, preferably a motor current, which depends upon a torque of the mixer of the food processor,
a temperature, which in particular is acquired on the prepared food by a temperature sensor integrated in the food processor,
a core temperature of the prepared food,
a surface temperature of the prepared food,
a weight of the prepared food, wherein the weight is acquired by a scale integrated in the food processor,
a measurable parameter on the prepared food, which in particular is specific to a completion time of the prepared food,
a time duration, preferably a mixing duration of the mixer, in particular since the time of activation of the preparation mode,
a brightness, which is acquired, for example, by an optical sensor on the prepared food,
a noise level, which in particular is acquired on the prepared food by an acoustic sensor,
at least one user input,
a consistency of the prepared food,
an electric property of the prepared food, preferably of the electric resistance of the food,
an odorous substance concentration on the prepared food and/or of the prepared food, preferably inside a mixing vessel of the food processor,
a gustatory substance concentration on the prepared food and/or the prepared food, preferably inside the mixing vessel of the food processor,
at least one chemical variable of the prepared food, in particular a pH value and/or a concentration of the prepared food,
a pressure in the region of the prepared food and/or a pressure curve, preferably in a mixing vessel of the food processor,
at least one spectral characteristic of the prepared food.

In this case, it is conceivable that the acquisition variable is acquired before and/or upon and/or after the preparation mode on the food. In particular, it is conceivable that an electronic database is provided, which includes e.g. comparison values for the respective acquisition variables, in order to evaluate the acquisition values in particular based upon these comparison values. In this way, for example based upon statistical methods, a plurality of acquisition variables can be put into relation with one another for the optimization of the preparation.

It is naturally also conceivable that a single acquisition value is identified in that and/or a single acquisition variable is acquired in that at least two or more sensors are evaluated (e.g. simultaneously). The use of a compound of multiple sensors makes a significant increase of quality of the preparation possible.

Moreover, it is conceivable that in the preparation mode, first acquisition values are identified periodically and/or repeatedly, and preferably parallel with it, i.e. e. g. within the same period of time or in the same cycle and/or essentially simultaneously, second acquisition values and/or further acquisition values are identified periodically and/or repeatedly in the preparation mode.

In particular, it is possible that the influencing of the further preparation mode is effected in such a way that an optimal completion timepoint of the prepared food is taken into account in the preparation, which time in particular is predetermined by the preparation record. To that end, e.g. also the optimal completion timepoint can be determined in that an evaluation of the acquisition variables is effected during the preparation. In particular, the control signal can be emitted temporally in such a way, e.g. by taken into account the latency time, that a deactivation of the preparation mode is caused at the completion time.

Furthermore, it is conceivable that the acquisition variable and/or a control parameter and/or a result parameter, preferably a first and/or second acquisition variable is a parameter of the surroundings outside the food processor, preferably
a spatial and/or geographical and/or local position of the food processor, in particular in the form of a GPS coordinate of the food processor, in order to adapt the preparation e.g. to geographical differences,
an information about the food and/or the preparation of the food, which is stored externally of the food processor, preferably in a (e.g. electronic) database, in order to preferably be retrieved via a network and/or in a cloud-based manner (i.e. e.g. from a remote computer via a network and/or via the Internet),
a product information of the food, in particular about producer-related properties and/or the ingredients and/or about an eat-by date, which is e.g. identifiable by the scanning of a barcode and/or other label, and/or is input manually by the user and/or retrieved from the database,
an air pressure outside the food processor,
an air humidity outside the food processor,
a temperature outside the food processor (e.g. temperature of the surroundings),
a time and/or day time and/or a date, which is identifiable e.g. via the database and/or a further database,
   wherein preferably the first acquisition variable is a parameter of the preparation surroundings (e.g. inside the mixing vessel) within the food processor.

Furthermore, it can be provided that the following steps are provided, preferably prior to step a) and/or for the initiation of the preparation:
setting and/or selecting a food to be prepared and/or a recipe (i.e. a recipe information) by a user input on the food processor,
selecting a preparation record dependent upon the set food or the recipe selection.

Furthermore, it is conceivable that a selection of the preparation record is effected in such a way that the preparation record is read out from a database dependent upon a set food, wherein preferably the database is provided locally and/or by a computer remote from the food processor (e.g. geographically remote or controllable via a network) cloud-based via a network and/or the Internet and/or by means of a in particular mobile data storage unit. A mobile data storage unit also concerns a USB memory stick, and/or another portable data memory that can be used e.g. in the food processor and/or can be connected with the food processor. Thus, new preparation records for the food processor can be provided in a flexible manner. In particular, the preparation specification can be selected dependent upon a food pre-set and/or provided for preparation, and/or be selected dependent upon a recipe (i.e. e.g. dependent upon a digitally stored recipe for the automatic preparation of the food). In this case, the database is e.g. a system for electronic data management, preferably software-based. In particular, it can be provided here that the selection of the preparation record is effected during the processing of a recipe, e.g. at a certain point of the recipe.

It can also be possible that the preparation record is stored in at least one data storage unit. The storage is effected in particular for the recording in accordance with step c), preferably locally in the food processor and/or on a remote computer. In this way, it is e.g. conceivable that for the recording and/or storage, the preparation record is transmitted at least partially via a network to a data storage unit of the remote computer. The recording and/or storage is effected e.g. only after the completion of the preparation, or continuously during the preparation. It can also be possible that a local storage of the (at least partial) preparation record is effected on a local data storage unit of the food processor in a temporary or persistent manner during the preparation, and preferably subsequently (e.g. after the completion of the preparation) the (buffered and/or locally stored and/or complete) preparation record is transmitted via the network to the remote computer and/or a remote data storage unit. This provides the advantage that even other users and/or food processors have access to the preparation record(s) provided on the remote computer. It can be possible that after the transmission to the remote computer, the preparation record is deleted locally (from the local data storage unit). In this way, it can advantageously be achieved that the local memory requirements (of the food processor) are reduced. It is also conceivable that (instead of or besides) the preparation record, even further information is transmitted from the food processor (via the network) to the remote computer. E.g. optimization specifications, e.g. evaluation and/or optimization algorithms, can be transmitted, which e.g. serve to evaluate the preparation record by the food processor. The optimization specification serves e.g. to control a processing device of the food processor (in the context of the computer program executed by the processing device). In particular, the optimization specification can thereby be provided for different food processor via the network (e.g. a LAN and/or the Internet and/or a mobile radio network) in that the optimization specification is stored in the remote computer. Alternatively or additionally, the optimization algorithm or the optimization specification is also part of the preparation record and thus serves e.g. to optimize and/or adapt a (further) preparation. Preferably, the optimization specification serves to perform the adaption and/or optimization of the recorded result values of the preparation record. It is furthermore conceivable that the record is performed in accordance with step c) and/or step a) and/or step b).

Particularly preferably, it can be provided that, in a preparation mode, the processing device, which preferably includes a mixer, is controlled to at least partially- automatically prepare different foods, in particular whipped cream and/or pasta and/or rice and/or recipes such as e.g. risotto or ice, dependent upon control parameters, wherein at least one food-specific or recipe-specific preparation record is provided and/or prestored for this food or recipes. Alternatively or additionally, it can be provided that a preparation record includes an information item about an acquisition variable selection (in particular a selection of control parameters or result parameters), wherein the preparation record is selected e.g. dependent upon the set food or recipe, and in the acquisition (only) the acquisition variables are acquired that are predetermined by the acquisition variable selection of the selected preparation record, so that in particular in the selection of a first prepared food or recipe, at least one different acquisition variable is acquired than in the selection of a second prepared food or recipe. In particular, the acquisition variable selection also serves for the parametrization of the control of the processing device(s). Preferably, the preparation record can be read out with the acquisition variable selection and/or only the acquisition variable selection from an (e.g. electronic) database. This allows the flexible use of different foods.

The invention also relates to a food processor comprising at least one processing device and/or a monitoring device, wherein in a preparation mode, the processing device is controllable to at least partially-automatically prepare food. In particular, it can be possible that the monitoring device comprises two sensors. By the monitoring device and/or a first sensor, at least one control value can be identifiable by a first acquisition of a control parameter on the food processor. Furthermore, in particular by means of the monitoring device and/or at least one second sensor, at least one result value can be determinable by a second acquisition of at least one result parameter on the food processor. In this case, it is particularly provided that the monitoring device includes a data storage unit, by means of which in particular the control value and/or the result vale can be stored in a preparation record, so that this (preparation record) can be assigned to the preparation as a recorded preparation. The data storage unit can in this case e.g. be in the form of a non-volatile data store, in particular an electronic data store.

Thus, the food processor according to the present invention provides the same advantages as have already been explained in detail with respect to the method according to the invention. In addition, the food processor according to the invention can be suited to be operated and/or operable in accordance with a method according to the invention.

Furthermore, it can possible that an input device of the food processor is provided. In particular, the input device comprises at least one operating panel and/or a rotary control and/or a rotary knob and/or a switch and/or a button. Preferably, the input device includes the first and/or the second and/or the third sensor. Preferably, the at least one result parameter is acquired by the input device and/or the first and/or second and/or third sensor.

Preferably, the result parameter includes at least one of the following parameters:
at least one temperature, in particular on the prepared food and/or the surroundings of the food processor,
a visual information of the prepared food, e.g. acquired by a camera sensor,
a weight of the prepared food, e.g. acquired by a scale of the food processor, wherein in particular the scale comprises the second and/or third sensor,
a quality parameter of the prepared food, e.g. acquired by a user input,
a parameter, dependent upon the preparation, on the food processor, preferably a motor current of a motor for a mixer unit of the food processor,
a user input, in particular a manual stop of a preparation step and/or preparation mode,
at least one acquisition variable and/or at least one preparation parameter.

Based upon the user input, e.g. the preparation duration of a certain preparation step of the recorded preparation can be identified. Thus, e.g. further preparations can be adapted to the used preferences.

Furthermore, it can be provided in the scope of the invention that the processing device includes at least one drive and/or a processing tool operable by the device, in particular a mixer of the food processor, and preferably the monitoring device is electrically connected to the drive, so that an acquisition of at least one of the acquisition variables (e.g. of the control parameter and/or result parameter) can be carried out by the monitoring device. Here, the monitoring can be effected by a sensor of the monitoring device, which is for example arranged in a manner as to be spaced in terms of construction, from the monitoring device (e.g. connected to the monitoring device electrically and/or via radio), for example in the region of the prepared food and/or in the region of the food processor provided to that end. Alternatively or in addition, it is conceivable that the first sensor and/or second sensor respectively perform the acquisition on the food, and are preferably arranged in the region and/or at least in part inside a mixing vessel of the food processor, in order to thereby be able to acquire the acquisition variables in a particularly reliable manner.

In addition, it can be provided that the food processor comprises a mixing vessel for accommodating the food, wherein in particular the mixing vessel is in the form of a thermo vessel to maintain the temperature of the food and/or is configured with a double wall. For example, the first and/or the second and/or another sensor can be provided and/or be arranged in the region of the mixing vessel in such a way, that a temperature inside the mixing vessel can be identified by the sensor and/or by the acquisition of the acquisition variables. This way, the temperature can be maintained and/or monitored, for example.

It is furthermore conceivable that the (first and/or second and/or another) sensor is integrated in the food processor, and preferably performs an acquisition of the acquisition variables inside and/or outside the mixing vessel, wherein the mixing vessel preferably can be detachably inserted into a mixing vessel holder of the food processor. As an alternative or in addition, it is also conceivable that the sensor is configured that it can be retrofitted in such a way that the sensor can be fitted, preferably inserted, into the food processor and/or a mixing vessel of the food processor and/or a cover of the mixing vessel in a detachable manner. This way, an existing sensor can be replaced and/or a new sensor can be retrofitted, in order to be able to perform the method according to the invention for additional foods and/or additional acquisition variables.

Furthermore, it is conceivable within the context of the invention that a mixing vessel holder of the food processor and/or a mixing vessel of the food processor that can be inserted in the mixing vessel holder and/or a lid of the mixing vessel that can be placed on the mixing vessel comprises at least one electrical contact for establishing an electrical connection to an electrical circuit of the food processor when in the inserted and/or placed-on state, preferably for supplying energy to the sensor and/or for data transmission (e.g. from the sensor to the monitoring device), wherein preferably the electrical contact is electrically connected to the sensor, in particular both in the inserted and/or placed-on state, and when not in the inserted and/or placed-on state. This allows to perform a reliable monitoring of the food, in particular by acquiring the acquisition variables by the sensor. In this case, the sensor is, for example, the first sensor and/or the second sensor and/or another sensor.

Furthermore, it can be possible that the at least one control value and/or the at least one control parameter is/are identified or acquired dependent upon the control or a setting and/or user input for the control of the at least one processing device or of the at least one processing tool, in particular of a mixer and/or of a heating element and/or the like. In particular, the control parameter includes the temperature (to be set) of the heating element and/or the speed and/or rotary direction of the mixer and/or the temporal activation period of one or more preparation steps (processing steps), which e.g. in turn respectively may comprise different values for control parameters.

Preferably, the result parameter includes an acquirable variable, which corresponds e.g. to the control parameter and/or to the acquisition variable and/or is different therefrom, e.g. also an optical record of the food and/or a motor current of a motor for a mixer of the food processor and/or the like.

It is furthermore conceivable for the food processor to comprise the at least one and/or at least two and/or at least three and/or more processing devices, which preferably each comprise at least one processing tool, preferably at least one mixer and/or at least one heating element. In particular, each processing device can comprise one sensor, respectively, the sensors for example differing from one another in each case, for example in order for it to be possible to identify a different acquisition variable in each case. It may furthermore be possible for the processing device to comprise at least one electric motor (e.g. electromotor), preferably for operating the mixer. In addition, the processing device can preferably comprise at least one temperature sensor and/or at least one scale and/or at least one current sensor and/or at least one voltage sensor, wherein it also is possible for the processing devices to be designed differently from one another in each case. For example, a first processing device is provided which comprises the mixer, and a second processing device is provided which in particular comprises the heating element and/or the temperature sensor. Furthermore, the food processor preferably comprises a housing which comprises a holder for a mixing vessel. The mixing vessel can for example be closed by a lid and in particular comprises a handle. The food to be prepared can in particular be poured into and/or received in the mixing vessel. The mixer and/or the heating element are preferably arranged in the inside of the mixing vessel, and can in particular act on the food in the mixing vessel. It may also be possible for the food processor to comprise at least one control panel which preferably comprises at least one display, preferably a touchscreen. In this place, the display is used for example as an input and/or output means for a user of the food processor and thus in particular serves for the user input. Further input means such as a rotary control and/or a set switch and/or the like may optionally also be provided. A user of the food processor can set and/or activate and/or deactivate for example control parameters and/or operating parameters, such as the mixer speed and/or the heating temperature and/or the time period for the mixing process (mixing duration) and/or different programs for the preparation by means of the control panel, in particular by means of the display in conjunction with the further input means. It is also conceivable for the control panel and/or the food processor to be designed such that the operating parameter to be set and/or a recipe selection can be selected using the touchscreen and/or such that the value for the selected operating parameter and/or a specific recipe can be set/selected using the further input means. Furthermore, it can also be possible that the preparation record is selectable and/or changeable and/or deletable via the user input.

It is furthermore possible in particular for the user to be able to set the food (i.e. in particular the type of food) and/or the preparation and/or the recipe for the food processor by means of the control panel. It may furthermore be possible for the user to be able to activate and/or deactivate the preparation mode (and/or a specific preparation step) of the food processor, in particular using the control panel and/or the further input means. In preparation mode, for example the mixer and/or a motor for operating the mixer is started, preferably for a specified temporal mixing duration (preparation duration). In particular, the preparation mode and/or a specific preparation step can be deactivated (e.g. at the latest) following said specified mixing duration, as a result of which the operation of the mixer and/or of the motor is also ended. Further preparation steps can follow, for example. Preferably, when preparation mode is activated the mixer speed is greater than 0 and when preparation mode is deactivated the mixer speed is 0. In this case, the deactivation of the preparation mode and/or the setting of control parameters and/or preparation parameters, in particular the mixer speed and/or the duration of the mixing process can take place for example manually and/or (partially) automatically, for example in a program-controlled and/or recipe-dependent manner (for example on the basis of the recipe selected) and/or in a food-dependent manner (e.g. on the basis of the state of the food). This in particular thus allows for the at least partially automatic preparation of the food.

It is furthermore conceivable for the acquisition variable and/or the preparation parameter (and/or the control parameter) to correspond to the operating parameter and/or to comprise the operating parameter, and/or for the acquisition variable and/or the acquisition value to be dependent on the operating parameter. The recipe (the recipe information) and/or each food that is set preferably comprises at least one (digitally stored) program for the preparation process.

The food processor and/or a mobile device (such as a mobile memory or recipe chip) for the food processor preferably comprises a non-volatile memory unit in which preparation parameters and/or at least one preparation record and/or an acquisition variable selection and/or pre-set operating parameters and/or programs and/or recipes are stored which are selected for example on the basis of input by the user. In this case, said operating parameters in particular also comprise control parameters, for example the mixer speed and/or the values for electrical parameters for controlling the motor of the mixer, in order to achieve a specified mixer speed. In this case, the preparation parameters preferably comprise the operating parameters and/or control parameters and/or further parameters at least in part, which parameters are relevant for the preparation. In particular, the preparation parameters each comprise information regarding, for example:
properties of the food processor and/or the control and/or acquisition variables and/or physical variables that are relevant for the preparation of the food and/or that are dependent on a preparation state;
the type of the acquisition variables to be acquired, for example a motor signal of the motor of the mixer, which is in particular dependent on the control of the motor and/or on the speed and/or the torque of the mixer,
the number of acquisition variables to be acquired.

The food that is prepared and/or to be prepared (i.e. provided for preparation and/or poured into the food processor) can preferably comprise at least one of the following foods, wherein a preparation record is selected and/or an acquisition variable selection is performed on the basis of the food for example:
pasta,
rice,
(cooked and/or fried) onions,
whipped cream,
dough,
sauces and/or emulsions,
ice mass.

The monitoring device in particular comprises an acquisition device and/or the at least one sensor, in order to identify acquisition values at the drive for example, and/or to acquire the acquisition variables. For this purpose, the monitoring device can also comprise at least one or more sensors which are integrated in the food processor and/or arranged on the food processor. In this case, the sensor and/or the sensors can be designed for example as temperature sensor and/or voltage sensor and/or current sensor and/or speed sensor and/or torque sensor. Accordingly, the acquisition values are formed as voltage acquisition values and/or current acquisition values and/or torque acquisition values and/or speed acquisition values and/or temperature acquisition values. This is advantageous in that the relevant acquisition values can be identified in a reliable manner.

Preferably, a third sensor for acquiring a third acquisition variable and/or a fourth sensor for acquiring a fourth acquisition variable and/or further sensors for acquiring further acquisition variables is also provided.

According to a further advantage, it may be possible for the processing device and/or the monitoring device to be integrated in the food processor, and in particular for the acquisition values to be identified directly by means of acquiring the acquisition variables at the processing device inside the food processor. For example, the processing device and/or the monitoring device may be arranged inside a housing (and/or on the housing at least in part) of the food processor and/or may be rigidly connected to further components of the food processor.

It is furthermore conceivable for the monitoring device to comprise an electrical and/or electronic processing device, and/or for the processing device and/or the monitoring device to comprise at least one electronic component. The electronic component for example comprises a microprocessor and/or a digital signal processor and/or a non-volatile storage unit and/or an application-specific integrated circuit (ASIC) and/or a field-programmable gate array (FPGA) and/or the like. In particular, the electronic component and/or a sensor that is connected to the monitoring device or integrated therein optionally also comprises an analogue-to-digital converter which is used for acquiring the acquisition variable for example.

The invention also relates to a computer program product for operating a food processor, in particular a food processor according to the invention. In this case, the computer program product is intended to be configured to carry out a method according to the invention. As a result, the computer program product according to the invention provides the same advantages as have been described in detail with reference to a method according to the invention and a food processor according to the invention. In addition, a computer program product according to the invention may also be suitable for being read out and/or executed by a processing device of a food processor according to the invention, in particular in order to carry out the method according to the invention. A computer program product according to the invention is for example firmware which is preferably used for operating the food processor according to the invention and/or can be digitally transferred to the food processor or the memory unit and/or processing device. Furthermore, the computer program product according to the invention may also be configured as a digital storage medium, in particular as a flash memory and/or a digital optical storage medium such as a CD and/or DVD and/or Blu-ray.

The invention also relates to a use of a food processor, in particular a food processor according to the invention, and/or according to a method according to the invention. In this case, in particular the use of the food processor is effected to record at least one partially-automatic (automated) preparation of at least one food (to be prepared), in particular by a preparation record. The recording is effected e.g. digitally and/or persistently and/or reproducible by the food processor. Thus, the use according to the invention provides the same advantages as have previously been described in relation to the food processor according to the invention and/or a computer program product according to the invention or a method according to the invention.

Further advantages, features and details of the invention can be found in the following description, in which embodiments of the invention are described in detail with reference to the drawings. In this case, the features mentioned in the claims and in the description may in each case be essential to the invention alone or in any desired combination. In the drawings:

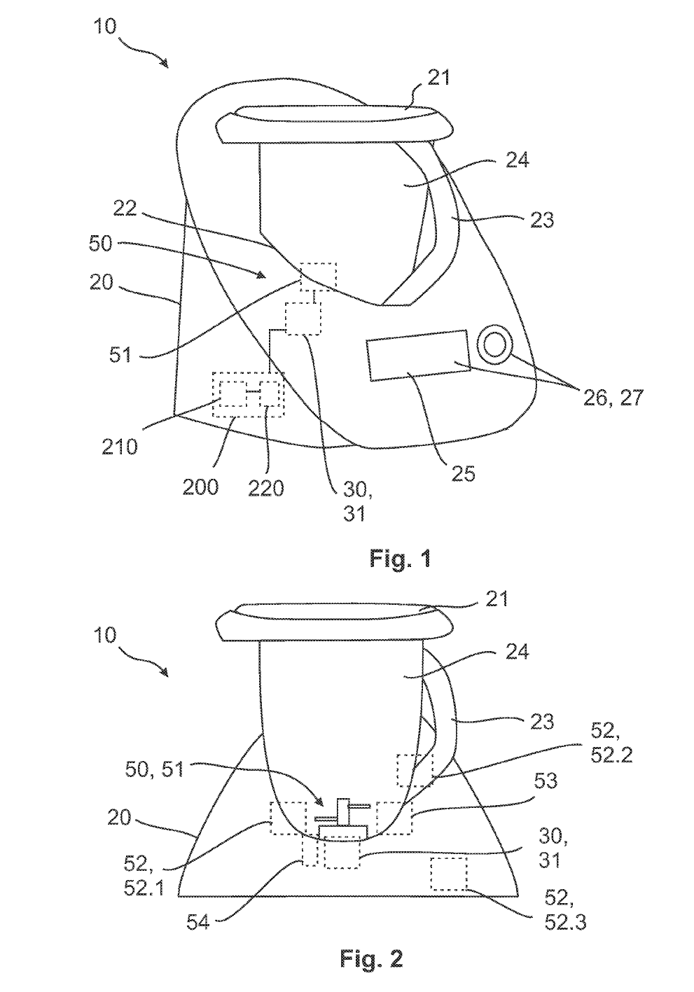

FIG. 1 is a schematic view of a food processor according to the invention,

FIG. 2 is a further schematic view of a food processor according to the invention, and

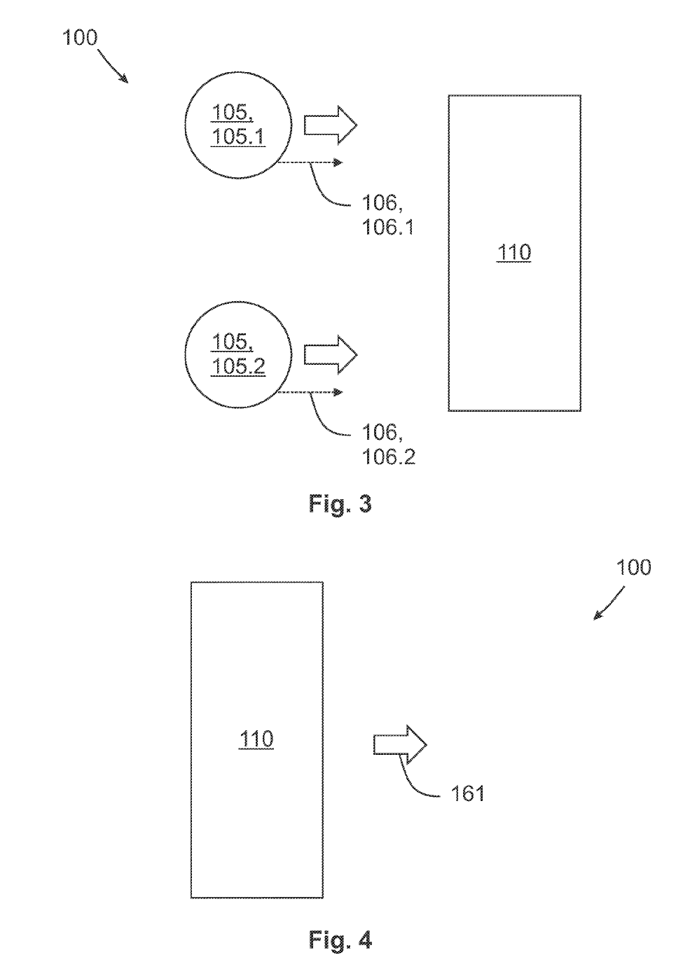

FIGS. 3-5 are schematic views for illustrating a method according to the invention.

In the following drawings, identical reference characters are used for the same technical features, even in different embodiments.

A food processor 10 according to the invention is shown schematically in FIGS. 1 and 2. The food processor 10 comprises a housing 20 which comprises a holder 22 for a mixing vessel 24. In this case, the mixing vessel 24 can for example be closed by a lid 21 and preferably comprises a handle 23. A mixer 51 and/or a heating element 53 and/or at least one sensor 52 is preferably arranged in the region of the mixing vessel 24 and/or in the inside of the mixing vessel 24. Furthermore, a first sensor 52.1 and a second sensor 52.2 as well as a third sensor 52.3 may also be provided, which sensors are each arranged for example at different regions of the food processor 10, inside or outside the food processor 10, for acquiring different acquisition variables. Moreover, the food processor 10 comprises a control panel 26 which for example comprises a display 25, preferably a touchscreen 25. In particular, the operating panel 26 serves as an input device 27. In this case, the display 25 is used in particular both as an input means and as an output means. The control panel 26 in particular makes it possible for a user of the food processor 10 to set and/or activate and/or deactivate preparation parameters and/or recipes and/or operating parameters, such as the mixer speed, the heating temperature and/or the time period for the preparation or the mixing process, and/or different programs of the food processor 10. Furthermore, the display 25 can also output recipe-related instructions and/or advice and/or graphical operating elements. Via the graphical operating elements, which preferably form part of a graphical user interface, an operation of the food processor 10 according to the invention can be performed as an input. The recipes are for example stored in a non-volatile memory 220 of the food processor 10. In particular, the input means also allows for a preparation mode to be activated and/or deactivated, and/or the setting of the type of preparation, and/or the type of food to be prepared, and/or (directly or indirectly) the type or number of acquisition variables to be acquired to be set and/or the selection of a preparation record 110.

As shown in FIGS. 1 and 2, the food processor 10 comprises at least one processing device 50, which in particular comprises at least one processing tool 51, such as a mixer 51. For the purpose of monitoring and/or control, in particular of the processing devices 50, at least one monitoring device 200 is furthermore provided, which device for example comprises a processing device 210 and/or the memory 220. It may furthermore be possible for the processing device 50 and/or further processing devices 50 to comprise the at least one sensor 52 and/or a heating means 53 and/or a scale 54 which are integrated in the food processor 10 for example. The scale 54 is used in particular for acquiring or measuring a weight force on the mixing vessel 24. For this purpose, the object to be weighed is for example placed on and/or poured into the mixing vessel 24. The heating means 53 is for example designed such that the food can be heated in the mixing vessel 24 by the heating means 53, preferably up to temperatures in a range of from 10° C. to 150° C., preferably 30° C. to 120° C.

FIG. 2 furthermore schematically shows a drive means 30 of the food processor 10, which drive means comprises an (electric) motor 31. In this case, the drive means 30 and/or the motor 31 is connected to at least one processing device 50 and/or to at least one processing tool 51, in particular the mixer 51, such that force transmission takes place from the motor 31 and/or a drive shaft of the drive means 30 to the processing device 50 and/or the processing tool 51 and/or the mixer 51. It may be possible for the monitoring device 200 to be electrically connected at least to the sensor 52 and/or to the processing device 50 and/or to the drive means 30 and/or to the motor 31 of the drive means 30 for the purpose of monitoring.

FIGS. 3 to 5 schematically show a method 100 according to the invention. According to FIG. 3, it can be discerned that for the generation of a preparation record 110 of a recorded preparation, a method according to the invention is to be performed. To that end, an acquisition of 105 of different acquisition variables is effected, in particular of control parameters and/or result parameters. E.g. by a first acquisition 105.1 of at least one control parameter during the preparation mode, at least one control value 106.1 is identified. Furthermore, by a second acquisition 105.2 of at least one result parameter, at least one result value 106.2 is identified.

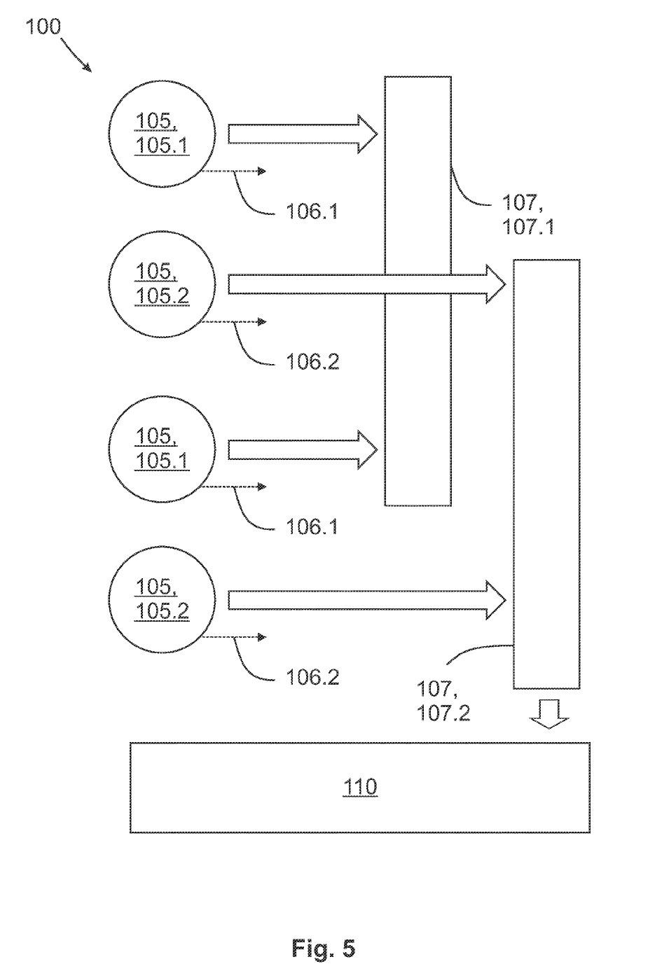

It is also conceivable that a course 107 of the acquisition values 106, which are identified by the acquisition 105, is identified and/or recorded. Thus, as illustrated e.g. in FIG. 5, a first course or curve 107.1 of the control values 106.1 and/or a second curve 107.2 of the result values 106.2 can be identified. This curve 107 is e.g. a temporal curve of the acquisition values 106, in particular a temperature progression or the like.

The determined acquisition values 106, in particular the control values 106.1 and/or result values 106.2, are subsequently recorded in the preparation record 110 and thus (permanently or persistently) stored. The persistent storage is particularly understood as that the preparation record 110 remains stored even after the food processor 10 is turned-off. To that end, a non-volatile data storage unit 220 of the food processor 10 can provided. In this case, the data storage unit 220 is in the form of a Flash memory or the like. Alternatively or additionally, it can be possible that the curve 107, in particular the first curve 107.1 and/or the second curve 107.2, is stored in the preparation record 110.

By the method steps of a method 100 according to the invention, shown in FIG. 3 and/or FIG. 5, it is e.g. possible, after the initiation of a preparation to be recorded, to record the individual preparation steps and/or the control parameters used thereby and/or the results of the preparation for a later use. Thus, it can be possible, for example, that a user of the food processor 10 uses the at least partially automatic preparation to produce e.g. fried or roasted onion, and/or to prepare dough. Thus, the preparation in particular includes multiple preparation steps, which include e.g. parameters such as the specification of the filling of food (e.g. of the onion or of grains) and/or the setting of a certain temperature of a heating element 53 of the food processor 10, and/or the setting of a certain rotary speed or rotary direction of a mixer 51 of the food processor 10, and/or the setting of a certain preparation duration of the individual preparation step, and/or other parameters for the control of a processing device 50 of the food processor 10, or the like. These parameters of the preparation steps can be acquired e.g. based upon the control parameters and/or result parameters and/or recorded by the identification and recording of the control values 106.1 and/or of the result values 106.2 for the late use in the recorded preparation record. In this way, e.g. the recorded preparation steps of the recorded preparation become fully or partially reproducible in the later use in a further preparation mode.

In this case, the control parameter is in particular specific to the preparation, so that preferably a change of the control parameter changes the preparation and/or the result of the preparation. The result parameter is in particular specific preparation result, so that preferably by means of the result parameter, the result (e.g. the quality) of the preparation can be assessed. To that end, analysis methods or the like can be employed which in particular are performed by the processing device 210 of the food processor 10. The result parameter is e.g. a visual record of the food and/or a user input and/or the like. In the broader sense, the result is also understood as the preparation duration of a single preparation step and/or the entire preparation duration of all preparation steps, so that the result parameter can in particular also concern a user input or be dependent thereupon, by which input the preparation step and/or the entire recorded preparation was stopped. For example, the user carries out the preparation to be performed in order to produce roasted onion. The roasting level in particular depends upon various parameters such as the temperature used and/or the food used (i.e. e.g. the type and/or consistence of the onions) and/or on the preparation duration. These parameters can e.g. be predetermined by a recipe information, but it is also conceivable that the user themselves adapts and/or influences these parameters in deviation from the recipe information. This can for example be effected by an early stop of the preparation and thus by a used-specific shortening of the preparation duration. Alternatively or additionally, it is also conceivable that an adaption is also automatically effected, e.g. by taking into account the influence of factors from the surroundings. Now, it can be possible through the acquisition of the at least one control parameter and/or of the at least one result parameter to determine this adaption of the parameters (e.g. by the user and/or by influence from the surroundings). To that end, e.g. based upon the result values 106.2 or of the result parameter, it is found out which adaption occurs, e.g. when the preparation and/or the preparation step was stopped.

FIG. 4 schematically illustrates the reproduction of the preparation record 110. To this end, for example, a further preparation is adapted in the same or in similar fashion as has been carried out in the recorded preparation by the evaluation of the preparation record 110 and/or by the output of at least one control signal 161, depending on this evaluation. This way, the recorded preparation can be repeated and/or the result of the recorded preparation can be reproduced. For example, a shortening of the preparation in the recorded preparation caused by a user input can now as well be carried out in the further preparation. This serves e.g. for considering a user-individual adaption of the preparation, e.g. a user-specific adaption of the preparation, for example a change in the grinding level and/or the roasting level, caused by the early stop of the preparation step.

It is also conceivable that the further preparation is adapted in such a way, in particular by an at least partially automated adaption of the preparation steps, that a predetermined preparation result is reproduced. The preparation result is for example determined based upon the preparation record 110. This way, it is possible, that not (only) the recorded preparation steps are adopted unchanged, according to the record, but that the further preparation steps of the further preparation (during the further preparation) are adapted (during the further preparation), e.g. based upon an evaluation, in such a way that, if possible, the predetermined preparation result is achieved. The preparation steps are therefore dependent upon the predetermined preparation result or upon the recorded result value 106.2, respectively. This comes with the advantage that also under different conditions of the surroundings, which influence the food or the preparation, the reproduction of the result desired by the user is possible. If it is determined during the further preparation of the food, that the specific consistency (or the roasting level or the like) of the at least one prepared food is already achieved in advance, although the recorded preparation duration (according to the recorded control value 106.1) is not yet reached, the current preparation step of the further preparation is adapted such that the preparation duration is shortened, in order to achieve the desired result. With a pure reproduction of the recorded preparation steps (e.g. based upon the recorded control value 106.1), this would not be possible. Of course, a combination of adaption can also be effected based upon the control value 106.1 (i.e. based upon the preparation steps) and based upon the result value 106.2 (i.e. based upon the preparation result).

The above explanation of the embodiments describes the present invention merely within the context of examples. Of course, individual features of the embodiments can, if technically reasonable, be combined with one another as desired without departing from the scope of the present invention.

### LIST OF REFERENCE CHARACTERS

10 food processor
20 housing
21 lid
22 mixing vessel holder
23 handle
24 mixing vessel
25 display
26 control panel
27 input device
30 drive
31 motor
50 processing device
51 processing tool, mixer
52 sensor
52.1 first sensor
52.2 second sensor
52.3 third sensor
53 heating element
54 scale
100 method
105 acquisition
105.1 first acquisition
105.2 second acquisition
106 acquisition values
106.1 first acquisition values, control value
106.2 second acquisition values, result value
107 curve
107.1 first curve
107.2 second curve
110 preparation record
161 control signal
200 monitoring device
210 processing device
220 non-volatile data storage unit

1-17. (canceled)

18. Method for operating a food processor, wherein at least one processing device of the food processor, in the preparation mode, is controlled to at least partially-automatically prepare at least one food,
wherein the following steps are provided:
a) identifying at least one control value by a first acquisition of at least one control parameter during the preparation mode, wherein the control parameter is specific to the preparation,
b) identifying at least one result value by a second acquisition of at least one result parameter, wherein the result parameter is specific to the result of the preparation,
c) recording the control value and the result value in a preparation record, so that said preparation record is assigned, as a recorded preparation, to the preparation.

19. Method according to claim 18,
wherein at least the following steps are carried out after step c):
d) evaluating the preparation record,
e) emitting at least one control signal for influencing the further preparation mode depending upon the evaluation, so that the further preparation is effected adapted to the preparation record.

20. Method according to claim 18,
wherein at least one of the recorded control value or the recorded result value is assigned to at least one preparation step in the preparation mode, wherein
an at least partially automatic adaption of at least one of the assigned preparation step, or of the or a further control parameter, is effected in a further preparation mode based upon the preparation record.

21. Method according to claim 18,
wherein for the initiating of the preparation mode, a recipe selection is carried out, and an adaption of the preparation mode based upon the preparation record is effected only in the event that a recipe selection predetermined by the preparation record corresponds to the performed recipe selection for the recorded preparation.

22. Method according to claim 18,
wherein during at least one further preparation mode, a monitoring of at least one of the result parameters or control parameters is effected to identify monitoring values, wherein the monitoring values are compared with the values of the, preparation record, and wherein a further preparation in the further preparation mode is adapted by means of the comparison, so that the further preparation is adjusted to the recorded preparation.

23. Method according to claim 18,
wherein by a recipe selection, a recipe information is selected, which includes at least one preparation step for the preparation in the preparation mode.

24. Method according to claim 18,
wherein during at least one further preparation mode, a monitoring of at least one of the result parameters or control parameters is effected to identify monitoring values, wherein the monitoring values are compared to the values of the, preparation record, and wherein the preparation record is adapted based upon the comparison.

25. Method according to claim 18,
wherein the preparation record is supplemented with information about at least one of at least one preparation step or about the at least one food used in the recorded preparation, so that a new recipe information is created, wherein the new recipe information is selected by a recipe selection, in order to carry out a further preparation mode depending upon the preparation record.

26. Method according to claim 18,
wherein according to step a), a temporal first course of the control parameter is acquired, and recorded according to at least one of step c), or according to step a) a temporal second course of the result parameter is acquired, and recorded according to step c).

27. Method according to claim 18,
wherein the control parameter includes at least one of the following parameters:
a temperature on the food processor,
a speed on the food processor,
a temporal preparation duration of an individual preparation step of the preparation in the preparation mode,
at least one of a quantity or quality of the prepared food,
a rotary speed on the food processor.

28. Method according to claim 18,
wherein according to step b), at least two result values are identified by the second acquisition of respectively different result parameters.

29. Method according to claim 18,
wherein the selection of at least one of the result parameters to be acquired or control parameters are stored in a parameter default, and the first and second acquisition (105.1, 105.2) is carried out dependent upon the parameter default.

30. Food processor comprising at least one processing device and a monitoring device,
wherein
in a preparation mode, the processing device is controllable to at least partially-automatically prepare food, and
the monitoring device comprises at least two sensors, and
by a first sensor at least one control value is identifiable by a first acquisition of at least one control parameter on the food processor, and
by at least one second sensor, at least one result value is identifiable by a second acquisition of at least one result parameter on the food processor,
wherein the monitoring device includes a data storage unit, by means of which the control value and the result value can be stored in a preparation record, so that said preparation record can be assigned as a recorded preparation.

31. Food processor according to claim 30,
wherein an input device of the food processor is provided.

32. Food processor according to claim 30,
wherein the food processor can be operated in accordance with a method for operating a food processor, wherein at least one processing device of the food processor, in the preparation mode, is controlled to at least partially-automatically prepare at least one food,
wherein the following steps are provided:
a) identifying at least one control value by a first acquisition of at least one control parameter during the preparation mode, wherein the control parameter is specific to the preparation,
b) identifying at least one result value by a second acquisition of at least one result parameter, wherein the result parameter is specific to the result of the preparation,
c) recording the control value and the result value in a preparation record, so that said preparation record is assigned, as a recorded preparation, to the preparation.

33. Computer program product for operating a food processor,
wherein the computer program product is configured to perform a method
method for operating a food processor, wherein at least one processing device of the food processor, in the preparation mode, is controlled to at least partially-automatically prepare at least one food,
wherein the following steps are provided:
a) identifying at least one control value by a first acquisition of at least one control parameter during the preparation mode, wherein the control parameter is specific to the preparation,
b) identifying at least one result value by a second acquisition of at least one result parameter, wherein the result parameter is specific to the result of the preparation,
c) recording the control value and the result value in a preparation record, so that said preparation record is assigned, as a recorded preparation, to the preparation.

34. Use of a food processor,
for recording an at least partially-automatic preparation of at least one food.

35. Method according to claim 18,
wherein at least the following steps are carried out after step c):
d) evaluating the preparation record if a further preparation mode for a further preparation is initiated.

36. Method according to claim 18,
wherein at least the following steps are carried out after step c):
d) evaluating the preparation record if a recipe selection is effected.

37. Method according to claim 18,
wherein
e) emitting at least one control signal for influencing the further preparation mode depending upon the evaluation, so that the further preparation is effected adapted to the preparation record, in such a way that the result of the recorded preparation is reproduced.

38. Food processor according to claim 30,
wherein an input device of the food processor is provided, which includes the second and/or a third sensor, wherein the result parameter includes at least one of the following parameters:
a temperature,
a visual information of the prepared food,
a weight of the prepared food,
a physical quantity on the food processor,
a quality parameter of the prepared food,
a parameter dependent upon the preparation, on the food processor,
a user input.

39. Method according to claim 24,
wherein the preparation record is adjusted to the further preparation, only in the event that a quality parameter of the result of the further preparation exceeds a recorded quality parameter of the result of the recorded preparation.
